(19) United States
(12) Patent Application Publication
(10) Pub. No.: US 2016/0231607 A1
(43) Pub. Date: Aug. 11, 2016

(54) STRUCTURE OF CURVED LIQUID CRYSTAL PANEL

(71) Applicant: SHENZHEN CHINA STAR OPTOELECTRONICS TECHNOLOGY CO. LTD., Shenzhen, Guangdong (CN)

(72) Inventors: Chuan WU, Shenzhen, Guangdong (CN); Jinbo GUO, Shenzhen, Guangdong (CN); Shihhsun LO, Shenzhen, Guangdong (CN)

(73) Assignee: Shenzhen China Star Optoelectronics Technology Co. Ltd., Shenzhen, Guangdong (CN)

(21) Appl. No.: 14/378,641

(22) PCT Filed: Jun. 12, 2014
(86) PCT No.: PCT/CN2014/079712

§ 371 Date: Aug. 13, 2014

(30) Foreign Application Priority Data
May 22, 2014 (CN) 201410219976.8

(51) Int. Cl. G02F 1/1339; G02F 1/1335; G02F 1/1368

(52) U.S. Cl. CPC G02F 1/13394; G02F 1/1368; G02F 1/133514; G02F 1/1339; G02F 2001/13396

(57) ABSTRACT

The present invention provides a structure of a liquid crystal panel, which includes a TFT substrate (1), a CF substrate (3) opposite to the TFT substrate (1), spacers (5) arranged between the TFT substrate (1) and the CF substrate (3), a liquid crystal layer (7) disposed between the TFT substrate (1) and the CF substrate (3), and an enclosing sealant layer (9) arranged between and located along a periphery of the TFT substrate (1) and the CF substrate (3). In a curving direction of the curved liquid crystal panel, the CF substrate (3) includes middle zone (31) and two side edge zones (33) at two opposite sides of the middle zone. The middle zone (31) bears a stress greater than stresses born by the two side edge zones (33). The spacers (51) that are located in the middle zone (31) are arranged to bear a stress that is greater than stresses born by the spacers (53) that are located in the two side edge zones (33) so as to maintain a constant distance between the CF substrate (3) and the TFT substrate (1) and achieve the consistency of cell thickness in the entirety of the curved liquid crystal panel.

### BACKGROUND OF THE INVENTION

1. Field of the Invention

The present invention relates to the field of liquid crystal displaying, and in particular to a structure of a curved liquid crystal panel.

2. The Related Arts

Liquid crystal displays (LCDs) have a variety of advantages, such as thin device body, low power consumption, and being free of radiation, and are thus of wide applications, such as liquid crystal televisions, mobile phones, personal digital assistants (PDAs), digital cameras, computer monitors, and notebook computer screens.

A liquid crystal display generally comprises an enclosure, a liquid crystal panel arranged in the enclosure, and a backlight module mounted in the enclosure. The liquid crystal panel has a structure that is generally composed of a thin-film transistor (TFT) array substrate, a color filter (CF) substrate, and a liquid crystal layer arranged between the two substrates and the principle thereof is that a driving voltage is applied to the two glass substrates to control rotation of liquid crystal molecules of the liquid crystal layer in order to refract out light emitting from the backlight module to generate an image.

Recently, with the progress of the liquid crystal displaying technology, major manufacturers have marketed curved liquid crystal displays one after another. Generally speaking, the curved liquid crystal displays allow for the best viewing effect from edge to edge, while a regular liquid crystal display has poor capability of displaying at edges of a screen. The curved liquid crystal displays have a screen that is entirely of a curved design to provide a wide full-view image, allowing for the same visual enjoyment at both the central portion and the peripheral portion of the screen and also reducing distortion of off-axis viewing for viewing at a short distance. Further, the curved liquid crystal displays allow a viewer's viewing distance to be extended, achieving better experience of viewing. Thus, compared to the regular liquid crystal displays, the curved liquid crystal displays have advantages, including: (1) brand differentiating, (2) wider viewable angle, and (3) reducing distortion for short distance viewing.

A curved liquid crystal panel is a core constituent component of a curved liquid crystal display. A conventional curved liquid crystal panel has a structure as shown in FIGS. 1 and 2 and comprising a TFT substrate 100, a CF substrate 200 that is opposite to the TFT substrate, spacers 300 that are arranged between the TFT substrate 100 and the CF substrate 200, a liquid crystal layer 400 arranged between the TFT substrate 100 and the CF substrate 200, and an enclosing sealant layer 500 that is arranged between located along a circumferential edge of the TFT substrate 100 and the CF substrate 200. The spacers 300 functions to support between the TFT substrate 100 and the CF substrate 200 to define a cell thickness. The spacers 300 are arranged between the TFT substrate 100 and the CF substrate 200 in an equal-dimension manner, of which the heights, the density, and the critical dimension (CD) values are generally identical. Such an arrangement suffers certain drawbacks, which result from the factor that the curved liquid crystal panel has certain curvature and after being curved, a relative sliding movement occurs between the TFT substrate 100 and the CF substrate 200 so that stresses that result from leftward and rightward sliding of the curved liquid crystal panel with respect to a reference point defined by a center thereof. The stresses are gradually reduced from the center towards opposite side edges and thus, the stresses resulting from mutual compression between the TFT substrate 100 and the CF substrate 200 are also gradually reduced from the center toward the opposite side edges. The stress born by the central portion of the curved liquid crystal panel is greater than the stresses born by the side edge portions. However, the spacers 300 are arranged in such a manner as to be of identical heights, density, and CD values and this results in a greater deformation in the central portion of the curved liquid crystal panel than those of the two opposite side edge portions, so that the cell thickness of the central portion is less than the cell thickness of the two side edge portions, leading to non-uniform distribution of the thickness of the liquid crystal layer and differences of light transmittance and response time between the central portion and the opposite side edge portions. Eventually, burring of the display images of the curved liquid crystal panel may result and the optical taste deteriorates.

### SUMMARY OF THE INVENTION

An object of the present invention is to provide a structure of a curved liquid crystal panel, which achieves a uniform cell thickness for the entirety of a liquid crystal plane and a uniform distribution of thickness of a liquid crystal layer, thereby making light transmittance and response time consistent and thus enhancing the optical taste of the curved liquid crystal panel.

To achieve the above object, the present invention provides a curved liquid crystal panel structure, which comprises: a thin-film transistor (TFT) substrate, a color filter (CF) substrate opposite to the TFT substrate, spacers arranged between the TFT substrate and the CF substrate, a liquid crystal layer disposed between the TFT substrate and the CF substrate, and an enclosing sealant layer arranged between and located along a periphery of the TFT substrate and the CF substrate, wherein in a curving direction of the curved liquid crystal panel, the CF substrate comprises a middle zone and two side edge zones at two opposite sides of the middle zone. The middle zone bears a stress greater than stresses born by the two side edge zones. The ones of the spacers that are located in the middle zone are arranged to bear a stress that is greater than stresses born by the ones of the spacers that are located in the two side edge zones so as to maintain a constant distance between the CF substrate and the TFT substrate.

The spacers that are located in the middle zone have heights that are greater than heights of the spacers located in the two side edge zones.

The heights of the spacers located in the middle zone are gradually reduced from a center toward two opposite sides in the curving direction of the curved liquid crystal panel.

The heights of the spacers of each of the side edge zones are gradually reduced from a side adjacent to the middle zone toward an opposite side in the curving direction of the curved liquid crystal panel or the heights of the spacers located in each of the side edge zones are substantially identical.

The spacers located in the middle zone are distributed in a density that is greater than densities of the spacers distributed in the two side edge zones.

The density of the spacers located in the middle zone is gradually reduced from a center toward opposite sides in the curving direction of the curved liquid crystal panel.

The density of the spacers located in each of the side edge zones is gradually reduced from a side adjacent to the middle zone toward an opposite side in the curving direction of the curved liquid crystal panel or the density of the spacers located in each of the side edge zones is substantially constant.

Critic dimensions of the spacers located in the middle zone are greater than critic dimensions of the spacers located in the two side edge zones.

The critic dimensions of the spacers located in the middle zone are gradually reduced from a center toward opposite sides in the curving direction of the curved liquid crystal panel.

The critic dimensions of the spacers located in each of the side edge zones are gradually reduced from a side adjacent to the middle zone toward an opposite side in the curving direction of the curved liquid crystal panel or the critic dimensions of the spacers located in each of the side edge zones are substantially identical.

The present invention also provides a curved liquid crystal panel structure, which comprises: a TFT substrate, a CF substrate opposite to the TFT substrate, spacers arranged between the TFT substrate and the CF substrate, a liquid crystal layer disposed between the TFT substrate and the CF substrate, and an enclosing sealant layer arranged between and located along a periphery of the TFT substrate and the CF substrate, wherein in a curving direction of the curved liquid crystal panel, the CF substrate comprising a middle zone and two side edge zones at two opposite sides of the middle zone, the middle zone bearing a stress greater than stresses born by the two side edge zones, the ones of the spacers that are located in the middle zone being arranged to bear a stress that is greater than stresses born by the ones of the spacers that are located in the two side edge zones so as to maintain a constant distance between the CF substrate and the TFT substrate;

wherein the spacers that are located in the middle zone have heights that are greater than heights of the spacers located in the two side edge zones;

wherein the heights of the spacers located in the middle zone are gradually reduced from a center toward two opposite sides in the curving direction of the curved liquid crystal panel; and

wherein the heights of the spacers of each of the side edge zones are gradually reduced from a side adjacent to the middle zone toward an opposite side in the curving direction of the curved liquid crystal panel or the heights of the spacers located in each of the side edge zones are substantially identical.

The efficacy of the present invention is that the present invention provides a structure of a curved liquid crystal panel, which uses an arrangement that the heights of the spacers located within a middle zone are greater than those of the spacers of two side edge zones, or the density of the spacers located within the middle zone is greater than the density of the spacers of the two side edge zones, or the critic dimensions of the spacers located within the middle zone are greater than those of the spacers of the two side edge zones to make the spacers located within the middle zone bear a stress greater than that of the spacers located within the two side edge zones, whereby the CF substrate and the TFT substrate may maintain a constant distance therebetween and thus the consistency of cell thickness in the entirety of the curved liquid crystal panel is achieved, the distribution of thickness of a liquid crystal layer is uniform, light transmittance and response time are made constant, and the optical taste of the curved liquid crystal panel is enhanced. The structure is simple and can be easily achieved.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional curved liquid crystal panel before being curved;

FIG. 2 is a schematic view showing the structure of a conventional curved liquid crystal panel after being curved;

FIG. 3 is a schematic view showing a structure of a curved liquid crystal panel according to a first embodiment of the present invention before being curved;

FIG. 4 is a schematic view showing the structure of the curved liquid crystal panel according to the first embodiment of the present invention after being curved;

FIG. 5 is a schematic view showing a structure of a curved liquid crystal panel according to a second embodiment of the present invention before being curved;

FIG. 6 is a schematic view showing the structure of the curved liquid crystal panel according to the second embodiment of the present invention after being curved;

FIG. 7 is a schematic view showing a structure of a curved liquid crystal panel according to a third embodiment of the present invention before being curved; and

FIG. 8 is a schematic view showing the structure of the curved liquid crystal panel according to the third embodiment of the present invention after being curved.

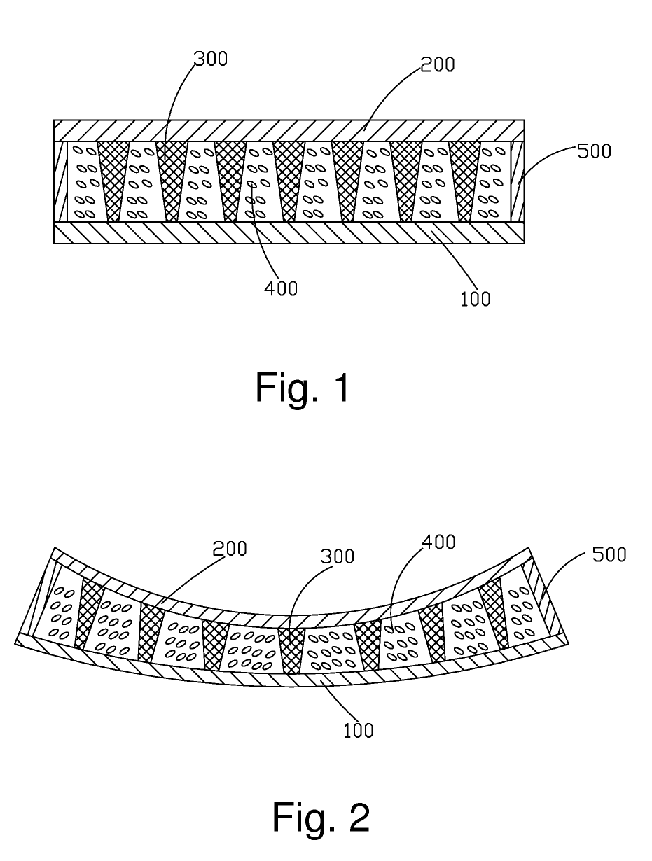

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

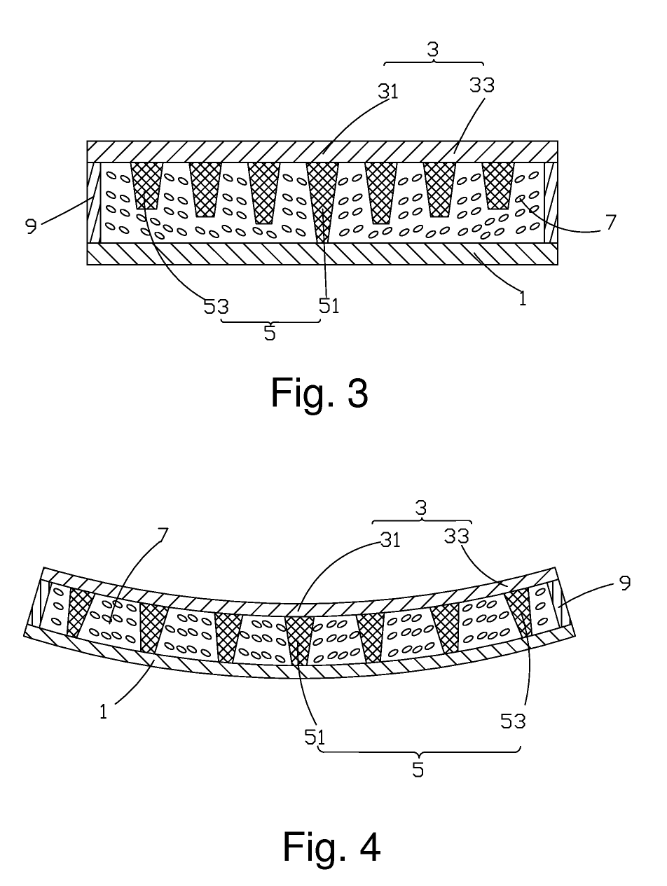

Referring to FIGS. 3 and 4, a structure of a curved liquid crystal panel according to a first preferred embodiment of the present invention is shown. The curved liquid crystal panel structure comprises: a TFT (Thin-Film Transistor) substrate 1, a CF (Color Filter) substrate 3 opposite to the TFT substrate 1, spacers 5 arranged between the TFT substrate 1 and the CF substrate 3, a liquid crystal layer 7 disposed between the TFT substrate 1 and the CF substrate 3, and an enclosing sealant layer 9 arranged between and located along a periphery of the TFT substrate 1 and the CF substrate 3. The TFT substrate 1 is provided to drive liquid crystal molecules contained in the liquid crystal layer 7 to rotate in order to carry out selection of light transmitting through the curved liquid crystal panel. The CF substrate 3 is provided to realize color displaying. The spacers 5 are provided to support a cell thickness between the TFT substrate 1 and the CF substrate 3 so as to allow the liquid crystal layer 7 to be distributed in a uniform manner. The enclosing sealant layer 9 is provided to seal the liquid crystal layer 7 between the TFT substrate 1 and the CF substrate 3.

The CF substrate 3 comprises a middle zone 31 and two side edge zones 33 at two opposite sides of the middle zone. Since when the curved liquid crystal panel is curved, a relative sliding movement is generated between the TFT substrate 1 and the CF substrate 3, the curved liquid crystal panel induces stresses for leftward and rightward sliding with respect to a reference point defined by a center thereof. The stresses are gradually reduced from the center toward the two side edges. Further, the stresses resulting from mutual compression between the TFT substrate 1 and the CF substrate 3 are also gradually reduced from the center toward the two side edges. Thus, the middle zone 31 bears a stress that is greater than those of the two side edge zones 33. The spacers 51 that are located within the middle zone 31 must be arranged to bear a stress that is greater than those born by the spacers 53 located within the two side edge zones 33 and then, the distance between the CF substrate 3 and the TFT substrate 1 can be kept consistent to thereby ensure a consistent cell thickness in the entirety of the curved liquid crystal panel.

In the first embodiment, the spacers 5 arranged between the TFT substrate 1 and the CF substrate 3 comprise the spacers 51 that are located within the middle zone 31 and the spacers 53 that are located within the two side edge zones 33 and the spacers 51 that are located within the middle zone 31 have heights that are greater than those of the spacers 53 located within the two side edge zones 33. Further, the heights of the spacers 51 within the middle zone 31 are gradually reduced from the center to the two side edges in a curving direction of the curved liquid crystal panel in order to accommodate the gradual reduction of the stresses from the center toward the two side edges. The heights of the spacers 53 within each of the side edge zones 33 are gradually reduced from the side adjacent to the middle zone 31 toward the opposite side in the curving direction of the curved liquid crystal panel, or alternatively, the heights of the spacers 53 within each of the side edge zones 33 are identical. And it is preferred that the heights of the spacers 53 within each of the side edge zones 33 are gradually reduced from the side adjacent to the middle zone 31 toward the opposite side in the curving direction of the curved liquid crystal panel. After the curved liquid crystal panel is curved, the stress born by and the extent of compression of the middle portions of the TFT substrate 1 and the CF substrate 3 are greater than the stress born by and the extent of compression of the two side edge portions of the TFT substrate 1 and the CF substrate 3. However, in the first embodiment, the heights of the spacers 51 within the middle zone 31 are arranged to be greater than the heights of the spacers 53 within the two side edge zones 33, so that the spacers 51 of the middle zone 31 may bear a stress greater than that born by the spacers 53 of the two side edge zones 33, whereby the CF substrate 3 and the TFT substrate 1 may maintain a constant distance therebetween and consistent cell thickness can be achieved in the entirety of the curved liquid crystal panel.

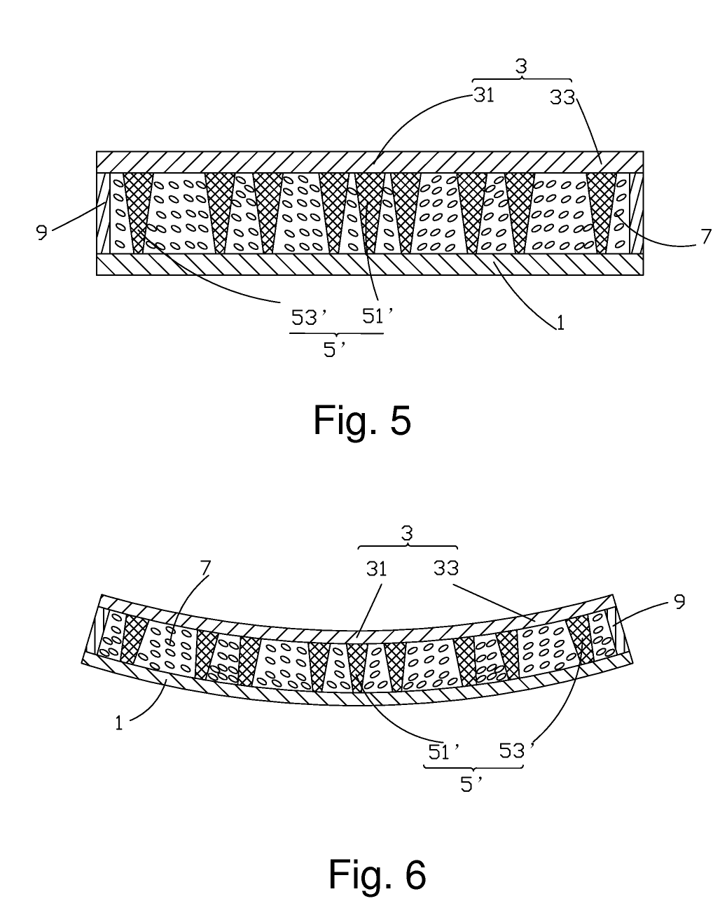

Referring to FIGS. 5 and 6, a structure of a curved liquid crystal panel according to a second preferred embodiment of the present invention is shown. In the second embodiment, the spacers 5′ arranged between the TFT substrate 1 and the CF substrate 3 comprise the spacers 51′ that are located within the middle zone 31 and the spacers 53′ that are located within the two side edge zones 33 and the spacers 51′ that are located within the middle zone 31 have a density that is greater than that of the spacers 53′ located within the two side edge zones 33. Further, the density of the spacers 51′ within the middle zone 31 is gradually reduced from the center toward the two side edges in a curving direction of the curved liquid crystal panel in order to accommodate the gradual reduction of the stresses from the center toward the two side edges. The density of the spacers 53′ within each of the side edge zones 33 is gradually from the side adjacent to the middle zone 31 toward the opposite side in the curving direction of the curved liquid crystal panel, or alternatively, the density of the spacers 53′ within each of the side edge zones 33 is constant. And it is preferred that the density of the spacers 53′ within each of the side edge zones 33 is gradually reduced from the side adjacent to the middle zone 31 toward the opposite side in the curving direction of the curved liquid crystal panel. After the curved liquid crystal panel is curved, the stress born by and the extent of compression of the middle portions of the TFT substrate 1 and the CF substrate 3 are greater than the stress born by and the extent of compression of the two side edge portions of the TFT substrate 1 and the CF substrate 3. However, in the second embodiment, the density of the spacers 51′ within the middle zone 31 is arranged to be greater than the density of the spacers 53′ within the two side edge zones 33, so that the spacers 51′ of the middle zone 31 may bear a stress greater than that born by the spacers 53′ of the two side edge zones 33, whereby the CF substrate 3 and the TFT substrate 1 may maintain a constant distance therebetween and consistent cell thickness can be achieved in the entirety of the curved liquid crystal panel.

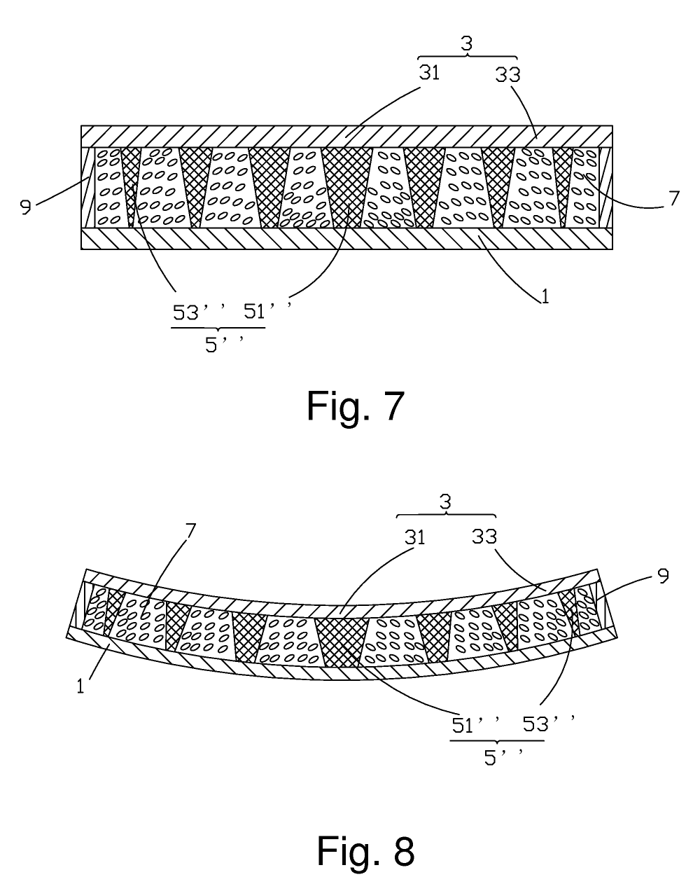

Referring to FIGS. 7 and 8, a structure of a curved liquid crystal panel according to a third preferred embodiment of the present invention is shown. In the third embodiment, the spacers 5″ arranged between the TFT substrate 1 and the CF substrate 3 comprise the spacers 51″ that are located within the middle zone 31 and the spacers 53″ that are located within the two side edge zones 33 and the spacers 51″ that are located within the middle zone 31 have critic dimensions that are greater than those of the spacers 53″ located within the two side edge zones 33. Further, the critic dimensions of the spacers 51″ within the middle zone 31 are gradually reduced from the center toward the two side edges in a curving direction of the curved liquid crystal panel in order to accommodate the gradual reduction of the stresses from the center toward the two side edges. The critic dimensions of the spacers 53″ within each of the side edge zones 33 are gradually from the side adjacent to the middle zone 31 toward the opposite side in the curving direction of the curved liquid crystal panel, or alternatively, the critic dimensions of the spacers 53″ within each of the side edge zones 33 are identical. And it is preferred that the critic dimensions of the spacers 53″ within each of the side edge zones 33 are gradually reduced from the side adjacent to the middle zone 31 toward the opposite side in the curving direction of the curved liquid crystal panel. After the curved liquid crystal panel is curved, the stress born by and the extent of compression of the middle portions of the TFT substrate 1 and the CF substrate 3 are greater than the stress born by and the extent of compression of the two side edge portions of the TFT substrate 1 and the CF substrate 3. However, in the third embodiment, the critic dimensions of the spacers 51″ within the middle zone 31 are arranged to be greater than the critic dimensions of the spacers 53″ within the two side edge zones 33, so that the spacers 51″ of the middle zone 31 may bear a stress greater than that born by the spacers 53″ of the two side edge zones 33, whereby the CF substrate 3 and the TFT substrate 1 may maintain a constant distance therebetween and consistent cell thickness can be achieved in the entirety of the curved liquid crystal panel.

It is noted here that the arrangements of the spacers 5 provided in the first, second, and third embodiments can be combined with each other in order to provide a better support to the TFT substrate 1 and the CF substrate 3 to ensure the consistency of the cell thickness in the entirety of the curved liquid crystal panel.

In summary, the present invention provides a structure of a curved liquid crystal panel, which uses an arrangement that the heights of the spacers located within a middle zone are greater than those of the spacers of two side edge zones, or the density of the spacers located within the middle zone is greater than the density of the spacers of the two side edge zones, or the critic dimensions of the spacers located within the middle zone are greater than those of the spacers of the two side edge zones to make the spacers located within the middle zone bear a stress greater than that of the spacers located within the two side edge zones, whereby the CF substrate and the TFT substrate may maintain a constant distance therebetween and thus the consistency of cell thickness in the entirety of the curved liquid crystal panel is achieved, the distribution of thickness of a liquid crystal layer is uniform, light transmittance and response time are made constant, and the optical taste of the curved liquid crystal panel is enhanced. The structure is simple and can be easily achieved.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A curved liquid crystal panel structure, comprising: a thin-film transistor (TFT) substrate, a color filter (CF) substrate opposite to the TFT substrate, spacers arranged between the TFT substrate and the CF substrate, a liquid crystal layer disposed between the TFT substrate and the CF substrate, and an enclosing sealant layer arranged between and located along a periphery of the TFT substrate and the CF substrate, wherein in a curving direction of the curved liquid crystal panel, the CF substrate comprises a middle zone and two side edge zones at two opposite sides of the middle zone, the middle zone bearing a stress greater than stresses born by the two side edge zones, the ones of the spacers that are located in the middle zone being arranged to bear a stress that is greater than stresses born by the ones of the spacers that are located in the two side edge zones so as to maintain a constant distance between the CF substrate and the TFT substrate.

2. The curved liquid crystal panel structure as claimed in claim 1, wherein the spacers that are located in the middle zone have heights that are greater than heights of the spacers located in the two side edge zones.

3. The curved liquid crystal panel structure as claimed in claim 2, wherein the heights of the spacers located in the middle zone are gradually reduced from a center toward two opposite sides in the curving direction of the curved liquid crystal panel.

4. The curved liquid crystal panel structure as claimed in claim 2, wherein the heights of the spacers of each of the side edge zones are gradually reduced from a side adjacent to the middle zone toward an opposite side in the curving direction of the curved liquid crystal panel or the heights of the spacers located in each of the side edge zones are substantially identical.

5. The curved liquid crystal panel structure as claimed in claim 1, wherein the spacers located in the middle zone are distributed in a density that is greater than densities of the spacers distributed in the two side edge zones.

6. The curved liquid crystal panel structure as claimed in claim 5, wherein the density of the spacers located in the middle zone is gradually reduced from a center toward opposite sides in the curving direction of the curved liquid crystal panel.

7. The curved liquid crystal panel structure as claimed in claim 5, wherein the density of the spacers located in each of the side edge zones is gradually reduced from a side adjacent to the middle zone toward an opposite side in the curving direction of the curved liquid crystal panel or the density of the spacers located in each of the side edge zones is substantially constant.

8. The curved liquid crystal panel structure as claimed in claim 1, wherein critic dimensions of the spacers located in the middle zone are greater than critic dimensions of the spacers located in the two side edge zones.

9. The curved liquid crystal panel structure as claimed in claim 8, wherein the critic dimensions of the spacers located in the middle zone are gradually reduced from a center toward opposite sides in the curving direction of the curved liquid crystal panel.

10. The curved liquid crystal panel structure as claimed in claim 8, wherein the critic dimensions of the spacers located in each of the side edge zones are gradually reduced from a side adjacent to the middle zone toward an opposite side in the curving direction of the curved liquid crystal panel or the critic dimensions of the spacers located in each of the side edge zones are substantially identical.

11. A curved liquid crystal panel structure, comprising: a thin-film transistor (TFT) substrate, a color filter (CF) substrate opposite to the TFT substrate, spacers arranged between the TFT substrate and the CF substrate, a liquid crystal layer disposed between the TFT substrate and the CF substrate, and an enclosing sealant layer arranged between and located along a periphery of the TFT substrate and the CF substrate, wherein in a curving direction of the curved liquid crystal panel, the CF substrate comprises a middle zone and two side edge zones at two opposite sides of the middle zone, the middle zone bearing a stress greater than stresses born by the two side edge zones, the ones of the spacers that are located in the middle zone being arranged to bear a stress that is greater than stresses born by the ones of the spacers that are located in the two side edge zones so as to maintain a constant distance between the CF substrate and the TFT substrate;
wherein the spacers that are located in the middle zone have heights that are greater than heights of the spacers located in the two side edge zones;
wherein the heights of the spacers located in the middle zone are gradually reduced from a center toward two opposite sides in the curving direction of the curved liquid crystal panel; and
wherein the heights of the spacers of each of the side edge zones are gradually reduced from a side adjacent to the middle zone toward an opposite side in the curving direction of the curved liquid crystal panel or the heights of the spacers located in each of the side edge zones are substantially identical.
